(19) United States
(12) Patent Application Publication
(10) Pub. No.: US 2020/0397180 A1
(43) Pub. Date: Dec. 24, 2020

(54) Combination Coffee Maker and Hot Jug

(71) Applicants: Masoud S. Rabadi, North Hills, CA (US); Chris Rabadi, North Hills, CA (US)

(72) Inventors: Masoud S. Rabadi, North Hills, CA (US); Chris Rabadi, North Hills, CA (US)

(21) Appl. No.: 16/450,989

(22) Filed: Jun. 24, 2019

(51) Int. Cl. A47J 31/36

(52) U.S. Cl. CPC A47J 31/3623

(57) ABSTRACT

An on demand instant hot, dual dispensing, coffee maker features a bottom filled water reservoir tank. The coffee maker draws water from the reservoir tank and pumps it through a series of solenoid valves directing it to an on-demand instant water heater. The water is heated and pressurized to approximately 3 bar (approximately 43.5 psi). The pressurized hot water passes through the coffee capsule and then immediately dispenses into a user's cup.

### ASSOCIATED APPLICATIONS

This application claims priority of the filing date of provisional application Ser. No. 62/689,228 Docket RabodiM-06P filed Jun. 24, 2018.

### FIELD OF THE DISCLOSURE

The described invention relates to coffee brewing and dispensing apparatus as well as hot water heaters and especially to those manufactured by Oster®, Krups®, Keurig®, Hamilton Beach®, Coffeeboxx®, Braun®, Cuisinart®, and the like.

### BACKGROUND

It is well-known to make coffee in a coffee maker that comprises a reservoir, an electric water heater that is arranged to heat the water supplied from the reservoir and pass the hot water into a filter compartment. A coffee pot or vessel is provided under the filter compartment to collect coffee that is made by passing the hot water through coffee grounds supported by a filter in the bottom of the filter compartment. It is also known to have a keep-warm function that retains the coffee warm in the coffee pot as required until the coffee pot is removed to pour coffee into cups for drinking. Electrically operated coffee grinders are also known in which a blade or set of blades is rotated at high speed to grind coffee beans into suitably sized coffee grounds for use in a filter compartment. At present, the coffee makers and coffee grinders may be provided as separate domestic appliances. A coffee making device for use in aircraft and similar installations has a water-heating cylinder into the top of which cold water flows. A piston reciprocates in the cylinder and has a check valve. The piston is biased to up” position by a spring. When the piston is up, the check valve is normally closed. When water is dispensed through a dispenser valve from the bottom of the cylinder, cold water flows into the top, depressing the piston to force out hot water, the piston acting as a thermal barrier between the hot and cold water. When the cylinder is empty, the dispenser valve is closed and the check valve opened permitting cold water to fill the cylinder. The spring returns the piston to up” position and the check valve is closed.

As will be shown in the following description and accompanying illustrations, the instant apparatus is superior to currently available coffee makers because of its certain advances and their benefits as described.

### BRIEF DESCRIPTION OF THE DRAWINGS

Embodiments of the described apparatus are illustrated only as examples in the drawing figures accompanying this written description. Alpha-numerical call-outs are used to identify elements of the invention, wherein the same call-out refers to the same element as it may appear in the several drawing figures.

FIG. 1 is a perspective front view of the instant coffee/hot water maker;

FIG. 2 is a further perspective view thereof;

FIG. 3 is a still further perspective view thereof;

FIG. 4 is a yet still further rear perspective view thereof showing wiring details;

FIGS. 5 and 6 are further rear perspective views thereof showing details of components and wiring;

FIG. 7 is a further rear perspective view thereof showing additional components;

FIG. 8 is a front perspective view thereof showing a cabinet enclosure;

FIG. 9 is a section taken along cutting plane line A-A at FIG. 10;

FIG. 10 is a side view thereof showing outside dimensions;

FIG. 11 is a front view thereof; and

FIG. 12 is a front perspective view thereof.

### DETAILED DESCRIPTION OF THE INVENTION

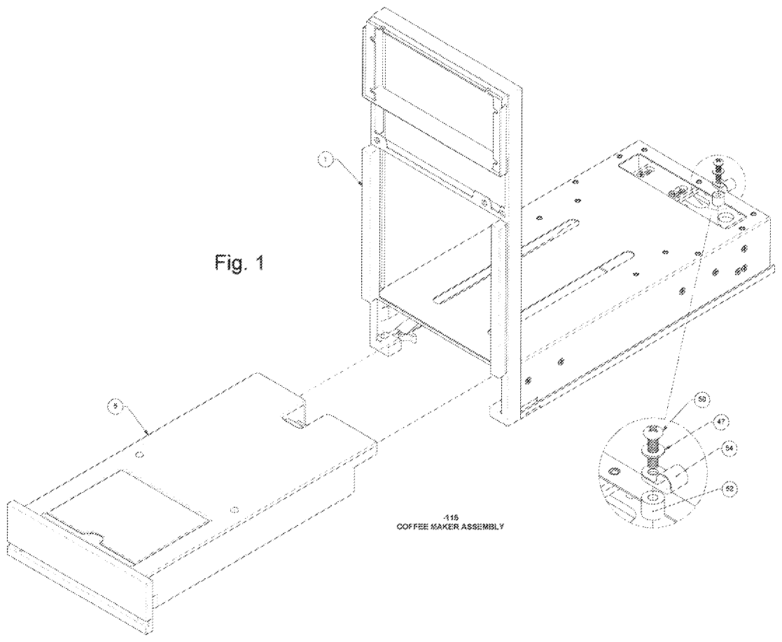

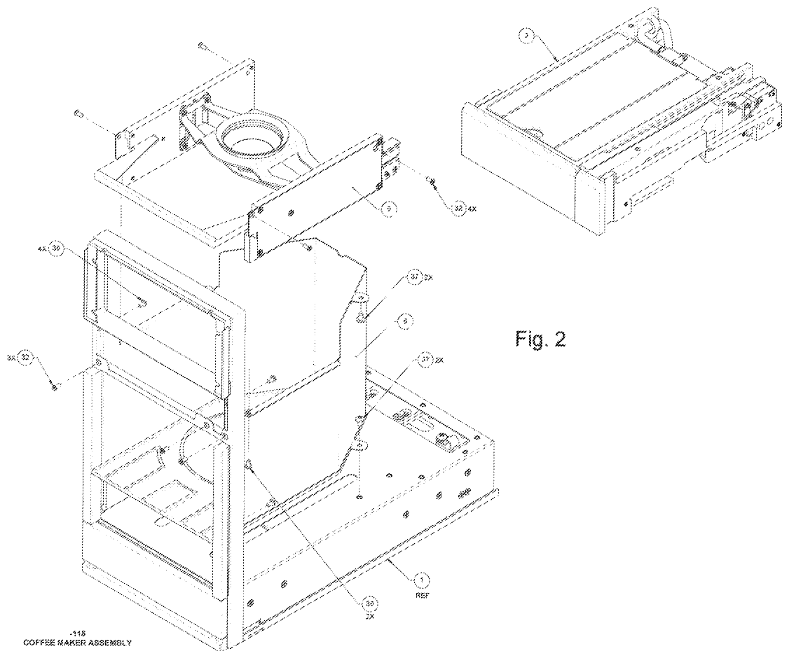

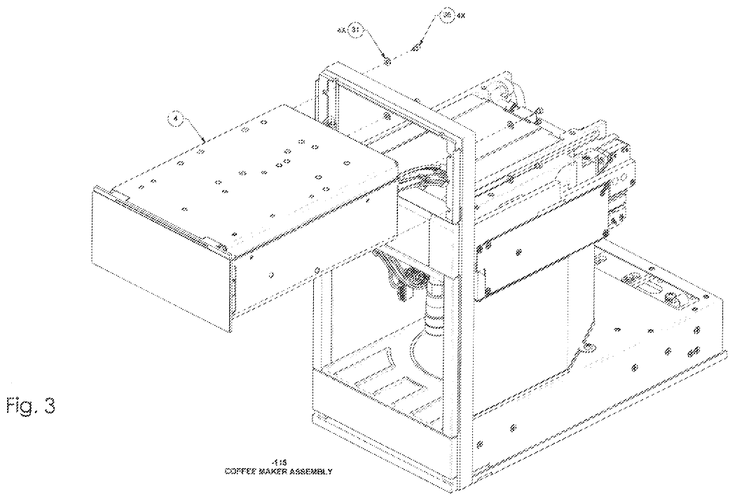

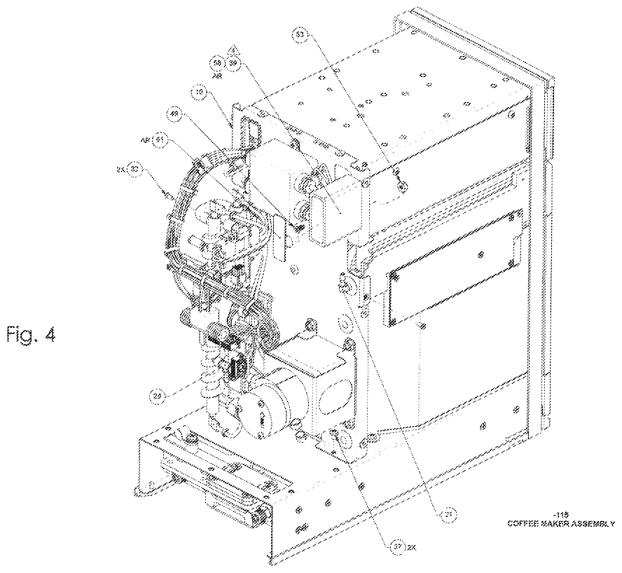

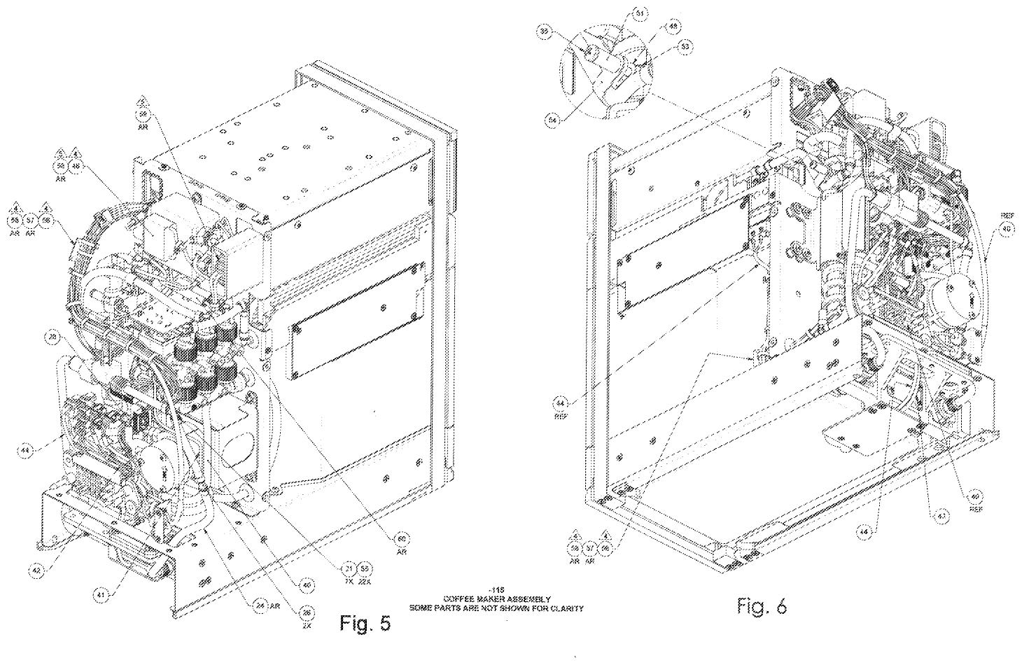

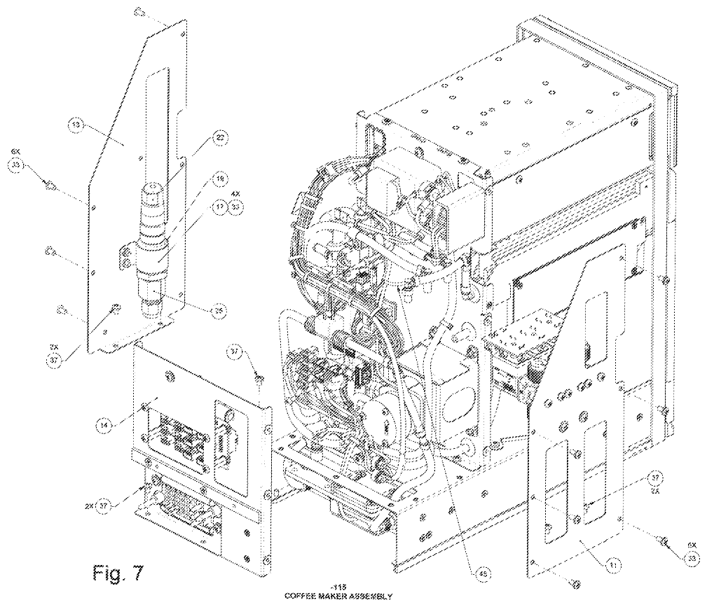

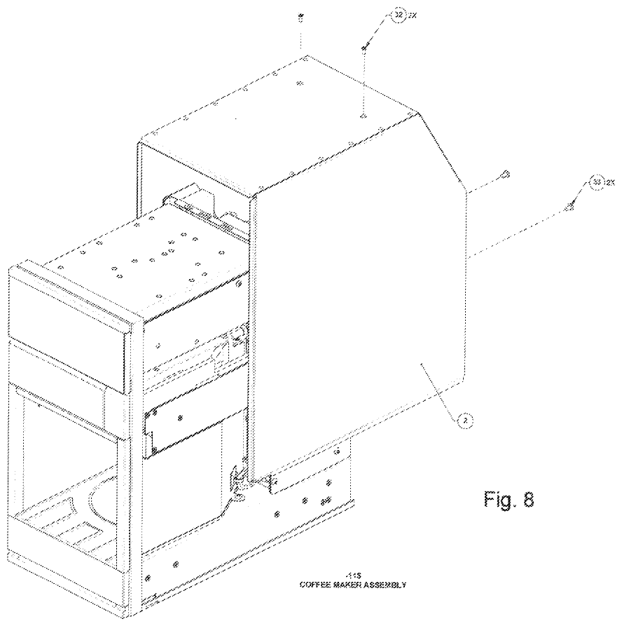

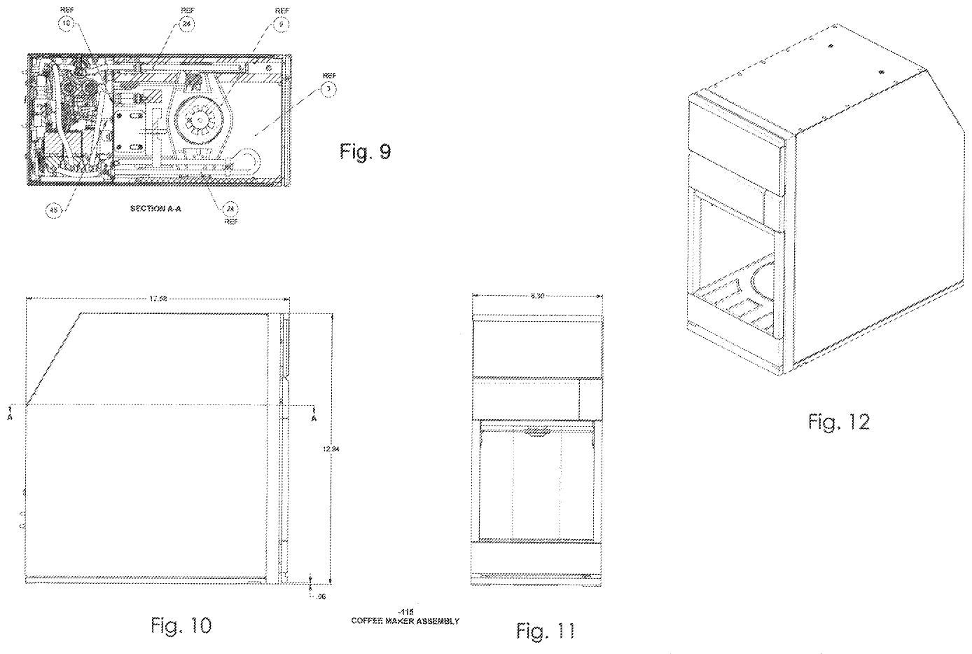

The herein described and illustrated invention in FIGS. 1-12 is an on demand instant hot dual dispensing coffee maker and hot jug (water heater) apparatus with a bottom filled water reservoir tank used to brew coffee or boil hot water for tea or soup. The unit draws the water from the bottom filled reservoir tank using a pump which pumps the water through a series of solenoid valves and directs the water to the on-demand instant hot water heater. The water is then heated to a pressure of approximately 3 bar (43.5 psi) which then fills into a brew basket over a coffee pillow pack to produce coffee, or with no pillow pack to simply produce hot water. The hot liquid is then dispensed into a carafe for instance.

An in-line heater system negates the need for a traditional boiler system, thereby reducing technical risk such as over-pressure conditions and the necessity for close management. Furthermore, the in-line heater system largely eliminates the lengthy pre-heat time associated with typical industry-standard boilers by enabling sufficiently hot brew within 1-2 seconds of activation while maintaining that ability throughout consecutive back-to-back dispenses. The in-line heater employs a primary aluminum heat-sink, two separate heater modules with brazed and coiled water tubing, a primary bracket which captures and constrains the heaters and heat sink, and a self-resetting thermostat switch, which is typically set to 275 F. Additionally, an integrated thermistor probe is used for real-time controller feedback, and an integrated one-shot thermal fuse is used in the event that the self-resetting thermostat fails to operate properly, or any other condition causes insufficiently control of the heater. A weight sensing reservoir tank; primary reservoir, employs thin-film force sensitive resistance pads and a controller based) inclinometer to calculate real time weight of the fluid in the reservoir tank which is used as a fill indication and empty water lock out.

1. An on demand instant hot dual dispensing coffee maker and hot jug comprising:
a bottom filled water reservoir tank;
a pump interconnected with the reservoir tank and a series of valves to a water heater; and a coffee capsule support.
